(19) United States
(12) Patent Application Publication
(10) Pub. No.: US 2014/0278505 A1
(43) Pub. Date: Sep. 18, 2014

(54) System for Processing and Settling Health Care Benefit Claims

(71) Applicant: Consilium, LLC, King of Prussia, PA (US)

(72) Inventor: Michael A. Salerno, Gilbertsville, PA (US)

(73) Assignee: Consilium, LLC, King of Prussia, PA (US)

(21) Appl. No.: 14/214,374

(22) Filed: Mar. 14, 2014

Related U.S. Application Data
(60) Provisional application No. 61/786,184, filed on Mar. 14, 2013.

(51) Int. Cl. G06F 19/00

(52) U.S. Cl. CPC G06F 19/328
USPC 705/2

(57) ABSTRACT

An automated system for administering health care insurance claims utilizes a series of rules, including a hierarchal set of Super Rules, specific Client Rules and General Rules, to apply selected criteria to the parameters of each respective insurance claim. When the criteria of a rule filter is met by the specific insurance claim parameters, an action is applied to the claim, allowing the insurance claim to be resolved without manual negotiation of the claim. If the criteria of none of the rule filters are met, the default action is a manual negotiation of the insurance claim by the claims administrator who is provided with a monitor display containing the pertinent information needed to negotiate a settlement discount for the health care service provided. The automated system provides a filter template to facilitate the creates of new rules to be applied to the administration of an insurance claim.

### CROSS-REFERENCE TO RELATED APPLICATIONS

This application claims domestic priority on U.S. Provisional Patent Application Ser. No. 61/786,184, filed on Mar. 14, 2013, the content of which is incorporated herein by reference.

### FIELD OF THE INVENTION

The present invention relates generally to the processing of health care benefit claims, and, more specifically, to a decision engine system for evaluating health care benefit claims to determine the best manner to secure the optimal discount for payment of n out-of-network health care benefit claim.

### BACKGROUND OF THE INVENTION

The processing of out-of-network insurance claims for health care expenses are typically administered through a claims processor that attempts to contain costs for the out-of-network insurance claims by categorizing the claims into a hierarchal category grouping. For example, the best return can be obtained through a preferred provider organization (PPO), which is a directed care provider; followed in order of return by a travel/wrap network, which is a semi-directed care provider; a PPO aggregator, which reflects no directed care; then a negotiated claim, which applies a fixed percentage to certain categories of claims; and finally to a usual and customary pricing schedule that provides the lowest return to the insurer of health care expenses. Typically, however, negotiating a health care benefit claim directly with a provider yields the greatest discount.

In U.S. Patent Application Publication No. 2010/0169124, of Howard Underwood et al, published on Jul. 1, 2010, a method of efficient administration of health care plans is disclosed in which data regarding a patient is processed to determine if an intervention in the patient's health care model is desired. A predictive model is used to determine the likelihood of a insurance plan participant filing a claim for disability within a certain period of time. The analysis of the data is presented to case managers in a user-friendly format to act in a manner consistent with the best interests of the participant.

In U.S. Patent Application Publication No. 2009/0177488, of Judith Unland, et al, published on Jul. 9, 2009, a standard financial network is used to settle the portion of a health care insurance claim not covered by the patient's health care insurance. The financial network is also used to determine if the patient has sufficient funds available to pay for the uncovered portion of an anticipated health care related expense. The settlement of the insurance claim can incorporate the eligibility check with the settlement process.

In U.S. Patent Application Publication No. 2009/0063197, of Michael Lisle published on Mar. 5, 2009, an automated process for paying a patient's non-covered medical expense from a health savings account is disclosed. The patient presents his machine readable health card to transmit the patient's data to a transaction processor at the time medical services are to be provided to the patient. The transaction processor sends the insurance company a statement for services rendered and adjudicates the claim to identify the uncovered amount corresponding to co-payments and deductible. The transaction processor then transmits the amount owed by the patient to the financial institution holding the patient's health savings account which issues payment to the medical provider.

The system for processing health care claims disclosed in U.S. Patent Application Publication No. 2008/0208757, of Oliver Bryant, et al, published on Aug. 28, 2008, provides real-time processing of a health care insurance claim by utilizing the Internet to transmit claim requests to a claim server that facilitates the transmission of the health care claim to the insurance payer. The response of the insurance payer is then transmitted to the medical care provider for communication with the patient. Data from a medical insurance claim is compared with stored data in U.S. Pat. No. 7,904,305, granted on Mar. 8, 2011, to Dirk Suringa. The comparison will identify errors in the data presented in the medical insurance claim to facilitate the eventual processing of the insurance claim.

U.S. Pat. No. 7,016,856, issued on Mar. 21, 2006, to Stephen Wiggins, discloses an automated system for administering health care claims by storing information regarding a plurality of contractual relationships between an alliance of organizations, a plurality of health care providers, and a plurality of insurance companies. In U.S. Pat. No. 6,826,536, granted to Bert Forman on Nov. 30, 2004, discloses a system for analyzing data to establish a database of medical specialty claims. Claims for medical costs submitted by medical providers are compared to the database to determine if the analyzed data falls within accepted guidelines and industry standards to identify improper or false claims. The system incorporates triggers that highlight claims that might indicate a possible fraudulent claim submission. This system provides a profile of provider's billing behavior for comparison with peers. U.S. Pat. No. 7,194,416, granted on Mar. 20, 2007, to Wayne Provost, et al, provides an interactive adjudication of health care insurance care by providing the person submitting the claim to amend the insurance claim to correct errors and facilitate payment.

It would be desirable to provide an automated system for routing out-of-network health care insurance claims to a negotiation process when certain predetermined criteria exist to allow the claims to be bundled for negotiation rather than direct the insurance claims to a PPO aggregator. It would also be desirable that the automated process for handling out-of-network health care insurance claims be consistently administered through the application of criteria in a hierarchal order. It would further be desirable to provide an automated system for administering out-of-network health care insurance claims that provides an administrator with a display that shows the pertinent information needed to negotiate the settlement of the insurance claim. It would also be desirable that the automated system provide flexibility in the application of predetermined criteria to the out-of-network insurance claims.

### SUMMARY OF THE INVENTION

It is an object of this invention to provide an automated system for the consistent handling of out-of-network health care insurance claims.

It is another object of this invention that the automated system for handling out-of-network health care insurance claims establish a hierarchy of criteria applied to the parameters of each respective health care insurance claim to provide a consistent administration of the insurance claims.

It is an advantage of this invention that the automated system for handling out-of-network health care insurance claims increases the capacity of claims that can be handled by a claims administrator.

It is a feature of this invention that the automated system for handling out-of-network health care insurance claims establishes consistency in the administration of the insurance claims as compared to a manual handling thereof by a claims administrator.

It is another feature of this invention that the automated system for handling out-of-network health care insurance claims provides the claims administrator with a monitor display showing all of the pertinent negotiation information needed for administering the health care insurance claim.

It is still another feature of this invention that the automated system for handling out-of-network health care insurance claims applies a series of Super Rules testing the criteria of the health care insurance claim.

It is another advantage of this invention that the Super Rules are applied in a hierarchal configuration so that a higher level Super Rule applies an action to the insurance claim when the criteria of the higher level Super Rule is met to move the insurance claim into a action category without applying the lower level Super Rules to the insurance claim parameters.

It is yet another feature of this invention that the automated system for handling out-of-network health care insurance claims applies specific Client Rules to an insurance claim being administered when the parameters of the insurance claim do not meet any of the criteria applied in the Super Rules, followed by an application of General Rules.

It is still another advantage of this invention that the default action of the automated system for handling out-of-network health care insurance claims, once the parameters of the insurance claim fails to meet the criteria applied by all of the Super Rules, Client Rules and General Rules, is to manually administer the insurance claim.

It is a feature of this invention that each Rule applied by the automated system for handling out-of-network health care insurance claims contains a filter through which the criteria of the Rule is applied to the parameters of the insurance claim and an action that is applied to the insurance claim if the parameters of the insurance claim meet the criteria of the filter.

It is yet another advantage of this invention that the automated system for handling out-of-network health care insurance claims has the flexibility of allowing the order of the Super Rules to be changed, thus applying criteria through a filter to the parameters of the insurance claim in a different order.

It is still another feature of this invention that during the manual negotiation of an out-of-network health care insurance claim, as the default action after the application of all of the Rules, the automated system provides the claims administrator with a monitor display that includes the previous history of the disposition of insurance claims made by the health care provider submitting the insurance claim, the maximum discount previously negotiated with the subject provider, the Medicare allowance for the specified service, the number of claims processed and resolved for the health care provider, the discount provided by a supplemental network that presents an optional resolution of the claim, and the discount typically accepted by other similar health care providers for the specified procedure or service.

These and other objects, features and advantages are accomplished according to the instant invention by providing an automated system for administering health care insurance claims that utilizes a series of rules, including a hierarchal set of Super Rules, specific Client Rules and General Rules, to apply selected criteria to the parameters of each respective insurance claim. When the criteria of a rule filter is met by the specific insurance claim parameters, an action is applied to the claim, allowing the health care insurance claim to be administered and resolved without manual negotiation of the claim. If the criteria of none of the rule filters are met, the default action is a manual negotiation of the insurance claim by the claims administrator who is provided with a monitor display containing all of the pertinent negotiation information needed to negotiate a settlement discount for the health care service provided. The automated system provides a filter template to facilitate the creates of new rules to be applied to the administration of an insurance claim.

### BRIEF DESCRIPTION OF THE DRAWINGS

The foregoing and other objects, features, and advantages of the invention will appear more fully hereinafter from a consideration of the detailed description that follows, in conjunction with the accompanying sheets of drawings. It is to be expressly understood, however, that the drawings are for illustrative purposes and are not to be construed as defining the limits of the invention.

FIG. 1 is a schematic process flow diagram of a process for evaluating and administering health care benefit claims incorporating the principles of the instant invention;

FIG. 2 is a display screen made available to a claim negotiator to provide an overview of the health care benefit claim being negotiated for settlement;

FIG. 3 is a display screen made available to a claim negotiator to provide benchmark data, a history of claim charges and negotiations with a particular health services provider submitting a health care benefit claim, and a summary of the detail of the health care benefit claim being negotiated; and

FIG. 4 is a logic flow diagram of the decision making process.

### DETAILED DESCRIPTION OF THE PREFERRED EMBODIMENT

Referring to the FIG. 1, an automated system for routing health care benefit claims, incorporating the principles of the instant invention, can best be seen. This system utilizes the Internet to receive the input of health care benefit claims from a client, and ultimately to transmit the decisions with respect to those health care benefit claims, and to direct those health care benefit claims to a computer server housing software for implementing the decision making process on how to evaluate and negotiate payment for these claims. The server would also have stored thereon, or have access to a remote server on which is stored, the proprietary database establishing analytical tools and benchmarks against which the health care benefit claims to be processed are evaluated.

The open health care claims submitted by a claims processing client are analyzed by the software to determine if the claim is a network claim, in which case the claim is directed immediately to the appropriate health care benefits network, or if the claim is an out-of-network claim. The out-of-network claims are then subjected to further analysis by the software to ascertain if the out-of-network claim should be directed to a preferred provider aggregator or be held for negotiation. The analytical software compares certain triggers to the out-of-network claims being reviewed, including modifiers, whether the claim is for surgery, whether the claim is for radiological services, whether a medical device is associated with the claim, etc.

In typical out-of-network claim routing, the claim is placed with the primary preferred provider organization (PPO) if possible because the Primary PPO will provide the greatest return to the client submitting the health insurance claim. However, the Primary PPO option is not available for all claims as the Primary PPO will only accept responsibility for those claims that fit into their specific criteria. Often, the out-of-network claims rejected by the Primary PPO will be sent to a PPO Aggregator who re-prices the claims and can usually force a predetermined reduction of the claim amount on the health care provider. Billed out-of-network claims are always highly inflated well above the actual cost of providing the health care services being billed. The inflation of the medical services corresponding to the triggers noted above are the most inflated and the use of a PPO Aggregator to apply a straight percentage discount does not provide the best pricing for the client. Thus, negotiating such claims directly will provide the greater discount for the client.

Traditional claims negotiation starts with the billed charge on the submitted out-of-network claim. As a result, this “top down” approach leaves less room for negotiating deeper discounts and, typically, results in 15-22% discount from the total billed charge on the out-of-network claim. By identifying groups of out-of-network claims through the analytical process of the instant invention, the negotiation of an applied discount can start at a benchmark defined within the system proprietary database 20, that benchmark pricing being substantially lower than the total billed charge on the out-of-network claim, yet still greater than the actual cost of providing the billed services. A discount on the benchmark pricing from the proprietary database results in a greater overall discount than is normally attainable through traditional negotiation strategies, which discount is enhanced by having a larger grouping of similar claims which are negotiated together, rather than individually.

These traditionally negotiated out-of-network claims are first coded properly so that the analytical software can identify the necessary triggers if the triggers are present on each particular out-of-network claim being submitted. The claims are then analyzed within the analytical software to identify one of more of the triggers which if detected results in the individual claim being pulled from the process and held for subsequent negotiation. Out-of-network claims that do not incorporate any of the predetermined triggers are then passed to a PPO Aggregator or paid using known and established usual and customary re-pricing techniques.

These traditionally processed out-of-network claims held and grouped for subsequent negotiation are first re-priced to a benchmark from among national, regional and local benchmarks for the specified groups of services as a ceiling price limit, and then compared to Medicare reimbursement pricing for the specified groups of services to define a floor price limit. The ceiling and floor price limits define a range demonstrating a fair market value for the services rendered. Although the actual cost of the services on any individual claim may vary, accumulating multiple claims into a common category for negotiations provides adequate incentive for averaging out the acceptable discount for the ultimate negotiated price for the submitted claims. The agreed upon discount is then applied to each individual out-of-network claim and then closed. Once closed, the claim is returned to the client as a closed claim and a report is provided.

Utilizing the approach to claim routing established according to the instant invention, all claims can be processed by a computer with the in-network claims immediately directed to the appropriate network for processing, while all out-of-network claims are subjected to additional analysis by the computer. First, the sophisticated analytical tools of the computer software allows for proper claim routing by identifying the appropriate triggers from the submitted claims that define these claims as having a high likelihood of deeper discounts because of the type of service provided under the out-of-network claim. These identified claims are then segregated and grouped according to predefined criteria for subsequent negotiation. The larger number of out-of-network claims being negotiated together according to the principles of the instant invention results in greater savings to the client and lower healthcare costs.

The process, as is reflected in the logic flow diagram shown in FIG. 4, involves the analysis of the parameters of a health care benefit claim by a computer, including, among others, the codes for the health care provider, the procedure or service provided by the health care provider, the cost of the procedure or service provided and whether or not the claim meets the guidelines of the Center for Medicare and Medicaid Services (CMS). The computer then applies a series of Super Rules to the health care benefit claim. Although the Super Rules are flexible and can be changed to be adapted to apply to any specific client, the Super Rules generally identify any parameter that triggers a specific desired action. If none of the Super Rules trigger a specific action, the computer then applies a series of General Rules that apply client specific filters to the parameters of the health care benefit claim to trigger an action. If no Super Rule or General Rule trigger an action, the default action would be to hold the health care benefit claim for review by a claims negotiator.

Each Super Rule includes a filter and an action that is triggered if the filter matches the appropriate parameter of the health care benefit claim. The filters of the Super Rules are generic in nature and are intended to be applicable to all health care benefit claims that are processed by the computer. The General Rules also have a filter and a designated action, but are intended to be client specific. Furthermore, one general Rule could be triggered when the filter matches a predetermined parameter of the health care benefit claim to have the action move the claim to a subset of General Rules. The filters in either the Super Rules or the General Rules are set up with condition operators and can be multiple step.

The filter may establish that a certain condition is met from a predetermined parameter, but not if another condition is also met by another parameter of the health care benefit claim. For example, a filter of a Super Rule could establish that a health care benefit claim for an emergency room procedure would trigger the filter, but only if the payment requested is greater than a certain threshold value. Furthermore, certain lists can be maintained in the computer database and the action for that Super Rule be triggered if the queried parameter is found on a specified list.

All of the Super Rules, as well as the General Rules, are applied in a predetermined order of priority. Once a Rule triggers an action, none of the Rules in the priority hierarchy below the triggered Rule will be queried. If the first Super Rule is not triggered, then the second Super Rule is queried, and so on sequentially, until a Super Rule is triggered, whereupon the predetermined associated action is taken and the health care benefit claim is removed from the system and acted upon according to the action of the Rule triggered. If the entire set of Super Rules is queried without triggering, then the General Rules are applied in the hierarchal order established for the General Rules until one of the General Rules is triggered. The default action if no Super Rule or General Rule is triggered is to hold the claim for review by a claims negotiator.

The Rules are established through a Filter Template and/or conditions that define the criteria that form the filter of the Rule. The Rule Template can group certain conditions together to be considered together before other conditions within the filter are considered. A filter, for example, could establish that a specified action is taken if a given parameter meets Condition A, but not if Condition B or Condition C are met where Condition B and Condition C relate to a different parameter of the health care benefit claim. In this situation, if either Condition B or Condition C are triggered by the corresponding parameter, then it doesn't matter if the parameter for Condition A is met or not. The Filter Template provides a great amount of flexibility in the formation of the filters for the Rules, both Super Rules and General Rules, and in the revision of the Rules.

As an example, a Super Rule can establish a filter that triggers all health care benefit claims that exceed a predetermined value. For example, if a claim for payment exceeds $50,000, the action would be to move the health care benefit claim to a claims negotiator for specific handling. Certain health care providers may have a standing contract with the claims processor to always accept a predetermined percentage discount of the billed charges, also known as an EverGreen filter. Thus, a Super Rule can be established to filter out all claims coming from such a health care provider with the action being that a fixed discount is applied according to the pre-existing contract and payment is made to the health care provider. Another Super Rule can be used to identify whether or not a provider is billing properly or fraudulently so as to direct the health care benefit claim to specifically trained negotiators.

For those out-of-network claims that do not trigger any of the Super Rules or the General Rules and are sent to a claims negotiator for processing, the parameters of the health care benefit claim are displayed on a monitor screen, such as is shown in FIGS. 2 and 3. Information from various databases are also displayed on the monitor screen to provide the claims negotiation with an abundance of information from which to negotiate a specific health care benefit claim, or a group of health care benefit claims, including historical information concerning the discount percentages negotiated for similar health care benefit claims with the specific health care provider, the standard charges accepted for the identified procedure or service by Medicare, the usual and customary charges for the identified procedure or service rendered, the number of claims processed and resolved for this health care provider, the discount provided by a supplemental network that presents an optional resolution of the claim, and the discount typically accepted by other similar health care providers for the specified procedure or service. Since the option of transferring the health care benefit claim to a supplemental network is a potential resolution of the health care benefit claim, the discount provided by the supplemental network presents a floor to the negotiations with the health care provider. If a better discount cannot be obtained through negotiations, a possible action by the claims negotiator could be to transfer the claim to the supplemental network.

Once a claim has been negotiated with a health care provider, a Settlement Agreement and Release is provided for execution by the health care provider before payment on the claim is made. The Settlement Agreement and release document is maintained in the computer database and provides security for the client with respect to further claims for payment from the client or from the recipient of the procedure or services.

Access to the authorized Medicare payment for specific procedures and services is an excellent tool to have available to a claim negotiator. Often settlement offers are phrased in the terms of a percentage of Medicare. With the computer operated decision engine pulling health care benefit claims into predetermined discounts without requiring personal attention from a claim negotiator, and with the abundance of statistical information made available to the claim negotiator when the disposition of the health care benefit claim is defaulted to the claim negotiator, the average payment made to health care providers can be substantially lowered from conventional results. In terms of percentage of Medicare, traditional health care benefit claims were paid at over 700% of the conventional Medicare payment, while utilization of the computer decision engine incorporating the principles of the instant invention should lower that average payment to less than 500% of Medicare, which is a significant savings to the client. Furthermore, less total health care benefit claims get assigned to claim negotiators which allow the claim negotiators to provide a better service to the customer and obtain deeper discounts.

In practice, the Super Rules can be applied in a hierarchy such as Super Rule #1 dismissing any claims that are duplicates of claims previously processed, Super Rule #2 routing any claims that are medically unlikely (for example, the claim has a clearly erroneous diagnosis or procedure code) to specifically trained negotiators, Super Rule #3 sending any claims directly to the claim negotiator that has a cost parameter that is clearly an excessive amount (as compared to a percentage of Medicare), Super Rule #4 immediately processing any claim associated with an existing contract defining a predetermined percentage, and Super Rule #5 sending to the claims negotiator any claim from a certain health care provider with which prior relationships exist in a prescribed manner. Then if none of the Super Rules are triggered, the General Rules are processed with General Rule #1 returning to a customer any claim accidentally sent for processing (such as a specified client that does not want emergency room claims or air ambulance claims negotiated), General Rule #2 sending to the claim negotiator any claim from a health care provider that has a history of not negotiating, etc.

Once a health care benefit claim has been resolved, the resolution is processed into the computer database. For example, a health care provider that has traditionally not negotiated claims might change his/her attitude and accept a proffered discount. That acceptance is then entered into the computer database and is reflected in the next health care benefit claim that is processed by the decision engine. Thus, the decision engine is a continuously growing and evolving with each claim that is negotiated or resolved in any manner. The application of the Super Rules and the General Rules will be affected accordingly.

The process according to the principles of the instant invention utilizes a proprietary database developed from historic health care claims that establish national, regional and local benchmarks for similar medical services that are utilized to establish a range of pricing that would be reasonable for the particular services rendered. Further comparing the services rendered to Medicare reimbursement figures defines a range of pricing into which a fair and reasonable payment would lie. This range of pricing is established by the analytical tools of the computer software, and a report is provided to a technician that can negotiate a comprehensive discount.

Processing out-of-network health insurance claims according to the principles of the instant invention minimizes disputes from the health care providers as these providers are signing off on the negotiated discount. Accordingly, the success rate for negotiated claims is higher than is normally expected from traditional claim negotiating techniques. With greater discounts based on benchmark levels rather than billed costs, the insurer has increased savings and health care costs are maintained.

The invention of this application has been described above both generically and with regard to specific embodiments. Although the invention has been set forth in what is believed to be the preferred embodiments, a wide variety of alternatives known to those of skill in the art can be selected within the generic disclosure.

Having thus described the invention, what is claimed is:

1. A method of processing health care claims corresponding to the receipt of services for a patient by a health care provider, comprising the steps of:
coding parameters of the health care claim;
inputting the coded parameters of the health care claim into a computer;
analyzing the parameters of the health care claim by applying a first set of rules to the parameters of the health care claim, each rule in said first set of rules including a filter and an action for application to the health care claim when the filter is matched to a corresponding parameter of the health care claim, said first set of rules being arranged in an order of priority such that each rule in said first set of rules is applied to the parameters of the health care claim in sequential order according to said order of priority;
if the parameters of the health care claim match the filter of one of the rules in said first set of rules, then applying the action to the health care claim according to the action of the rule of said first set of rules having the matched filter;
if none of the parameters of the health care claim match any of the filters of the rules of said first set of rules, then applying a second set of rules to the parameters of the health care claim, each rule in said second set of rules having a filter and an action for application to the health care claim when the filter of a rule in said second set of rules is matched to one of the parameters of the health care claim, each rule in said second set of rules being client specific;
if one of the filters of said second set of rules is matched to one of the parameters of the health care claim, then applying the corresponding action associated with the rule of said second set of rules having the matched filter; and
if none of the filters of the rules of the second set of rules matches one of the parameters of the health care claim, then designating the health care claim for manual negotiation.

2. The method of claim 1 wherein the rules of said first set of rules are parameter specific and triggers a specific predetermined action when the filter of one of the rules of said first set of rules is matched to the filter thereof.

3. The method of claim 2 wherein the first set of rules is reconfigurable to rearrange selectively the order of priority thereof.

4. The method of claim 3 wherein the application of the specified action of the corresponding rule of the first set of rules due to the matching of the filter thereof to one of the parameters of the health care claim prevents any subsequent rule in the order of priority of the rules of the first set of rules from being applied to the health care claim.

5. The method of claim 1 wherein the manual negotiation of the health care claim is accomplished by a designated negotiator who is provided with information on a single display from preselected databases to negotiate with the health care provider a re-pricing of the health care claim to define a discount for the client.

6. The method of claim 5 wherein the information provided to the designated negotiator includes one or more of the following:
a. historical information concerning discount percentages previously negotiated with the health care provider;
b. standard charges accepted for similar services by Medicare;
c. the usual and customary charges made by other health care providers for the services provided;
d. the number of claims processed and resolved with the health care provider;
e. the discount provided through a supplemental network that presents an optional resolution of the health care claim; and
f. the discount typically accepted by other similar health care providers for the services provided.

7. The method of claim 6 wherein the discount provided through a supplemental network establishes a floor for the negotiations with the health care provider in that the supplemental network will become the resolution of the health care claim if a better discount cannot be negotiated.

8. The method of claim 6 wherein at least some of the information provided to the designated negotiator is provided through access to a proprietary database developed from historic health care claims that establish appropriate benchmarks to define a range of pricing that would be reasonable for a variety of health care services.

9. The method of claim 5 wherein the designated negotiator also has available on the single display the parameters of the health care claim.

10. A method of repricing health care claims comprising the steps of:
coding parameters of the health care claim and entering said coded parameters of the health care claim into a computer;
analyzing the parameters of the health care claim by applying a first set of rules to the parameters of the health care claim, each rule in said first set of rules including a filter and an action corresponding to a discount of the health care claim for application to the health care claim when the filter is matched to a corresponding parameter of the health care claim, said first set of rules being arranged in an order of priority such that each rule in said first set of rules is applied to the parameters of the health care claim in sequential order according to said order of priority;
if the parameters of the health care claim match the filter of one of the rules in said first set of rules, then applying the action to the health care claim according to the action of the rule of said first set of rules having the matched filter to affect a repricing of the health care claim;
if none of the parameters of the health care claim match any of the filters of the rules of said first set of rules, then applying a second set of rules to the parameters of the health care claim, each rule in said second set of rules having a filter and an action for application to the health care claim resulting in a repricing of the health care claim when the filter of a rule in said second set of rules is matched to one of the parameters of the health care claim, each rule in said second set of rules being client specific;
if one of the filters of said second set of rules is matched to one of the parameters of the health care claim, then applying the corresponding action associated with the rule of said second set of rules having the matched filter to affect a repricing of the health care claim; and
if none of the filters of the rules of the second set of rules matches one of the parameters of the health care claim, then designating the health care claim for manual negotiation to affect a repricing of the health care claim.

11. The method of claim 10 wherein the rules of said first set of rules are parameter specific and triggers a specific predetermined action when the filter of one of the rules of said first set of rules is matched to the filter thereof.

12. The method of claim 11 wherein the first set of rules is reconfigurable to rearrange selectively the order of priority thereof.

13. The method of claim 12 wherein the application of the specified action of the corresponding rule of the first set of rules due to the matching of the filter thereof to one of the parameters of the health care claim prevents any subsequent rule in the order of priority of the rules of the first set of rules from being applied to the health care claim.

14. The method of claim 13 wherein the manual negotiation of the health care claim is accomplished by a designated negotiator who is provided with information on a single display from preselected databases to negotiate with the health care provider a re-pricing of the health care claim to define a discount for the client.

15. The method of claim 14 wherein the information provided to the designated negotiator includes one or more of the following:
a. historical information concerning discount percentages previously negotiated with the health care provider;
b. standard charges accepted for similar services by Medicare;
c. the usual and customary charges made by other health care providers for the services provided;
d. the number of claims processed and resolved with the health care provider;
e. the discount provided through a supplemental network that presents an optional resolution of the health care claim; and
f. the discount typically accepted by other similar health care providers for the services provided.

16. The method of claim 15 wherein the discount provided through a supplemental network establishes a floor for the negotiations with the health care provider in that the supplemental network will become the resolution of the health care claim if a better discount cannot be negotiated.

17. The method of claim 16 wherein at least some of the information provided to the designated negotiator is provided through access to a proprietary database developed from historic health care claims that establish appropriate benchmarks to define a range of pricing that would be reasonable for a variety of health care services.

18. The method of claim 17 wherein the designated negotiator also has available on the single display the parameters of the health care claim.
